(19) United States
(12) Patent Application Publication
(10) Pub. No.: US 2004/0052570 A1
(43) Pub. Date: Mar. 18, 2004

(54) Lint roller/brush assembly

(76) Inventor: William D. McKay, Grand Blanc, MI (US)

Correspondence Address: William M. Hanlon, Young & Basile, P.C., Suite 624, 3001 West Big Beaver Road, Troy, MI, 48084, US

(21) Appl. No.: 10/614,551

(22) Filed: Jul. 7, 2003

Related U.S. Application Data
(63) Continuation-in-part of application No. 10/329,717, filed on Dec. 26, 2002.
(63) Continuation of application No. 10/302,038, filed on Nov. 22, 2002.
Application No. 10/302,038 is a continuation-in-part of application No. 10/143,396, filed on May 10, 2002.
(60) Provisional application No. 60/426,589, filed on Nov. 15, 2002.

(51) Int. Cl. A47L 25/08; A46B 1/00; B43M 11/02; A47L 17/06

(52) U.S. Cl. 401/219; 15/104.002; 401/138

(57) ABSTRACT

A lint/pet hair roller assembly includes a body supporting a tubular adhesive lint remover roll. The assembly includes a handle and a roll support. The roller support includes a cross-member transversely mounted on the handle and carrying a pair of outwardly extending legs. Roll support members are fixed or rotatably carried on the legs for supporting a lint roll. The legs, in one aspect, are moveably mounted in the cross-member and biased to a normal first spacing to support a lint roll, but extendable outward for movement of the lint roll relative to the legs. In another aspect, a telescoping lint roll support is normally biased to an extended position to support the lint roll, but is collapsible for movement of the support relative to the legs. Alternately, a dispenser is carried on the handle for dispensing fluid from a storage chamber. Alternately, an additional cleaning element is carried on the support.

### CROSS-REFERENCE TO CO-PENDING APPLICATIONS

This application is a continuation-in-part of co-pending U.S. patent application Ser. No. 10/329,717, filed on Dec. 26, 2002, the contents of which are incorporated herein in its entirety, which claims the benefit of the priority filing date of U.S. Provisional Patent Application Serial No. 60/426,589, filed Nov. 15, 2002, and is a continuation of U.S. patent application Ser. No. 10/302,038, filed Nov. 22, 2002, which is a continuation-in-part of U.S. patent application Ser. No. 10/143,396 filed May 10, 2002.

### BACKGROUND

The present invention relates to a lint roller assembly.

There are many previously known lint roller assemblies. These previously known lint roller assemblies typically comprise a handle secured to a cylindrical lint roller support. A tubular cylindrical adhesive lint roller is then removably mounted to the support such that the adhesive roller is rotatively relative to the handle. In use, the adhesive lint roller is rolled along a surface to remove unsightly particles, lint, pet hair, etc.

The previously known lint roller assemblies have used a number of different options to rotatively secure the lint roller support to the handle. For example, in U.S. Pat. No. 4,361,923, the lint roller support and handle are separately constructed and then rotatively secured together. One disadvantage of this type of previously known lint roller assembly, however, is that the rotatively connection between the handle and lint roller support is subject to mechanical failure.

A further disadvantage to this type of assembly is that both the lint roller support and the handle are separately molded from plastic and then assembled together requiring two separate molds, one for each part.

Still other types of lint roller assemblies, such as that disclosed in U.S. Pat. No. 6,055,695, the lint roller handle includes a pair of elongated housing parts, which are substantially identical to each other. A disadvantage to this type of assembly is that each housing part must be snapped exactly into the other perfectly registering using pins and sockets. A further disadvantage is that the handle section being integral to the support section is manufactured with rigid plastic material and uncomfortable to grip and does not provide for a customized plastic decorative top or hanger.

Still other types of previously known lint roller assemblies, such as that disclosed in U.S. Pat. No. 4,5577,0111, utilize a unitary lint roller handle and lint roller support. These previously known lint roller assemblies, however, require a complex and, therefore, expensive mold design in order to mold the lint roller handle and support. Furthermore, a relatively large frictional engagement between the lint roller and the lint roller support often times interferes with the desired free rotation of the lint roller about the lint roller support. Further, it does not provide for mounting a directional lint brush fabric under the rotatable tape roll.

### SUMMARY

The present invention is a lint roller assembly which overcomes all of the deficiencies of the previously known lint roller art.

In one aspect, the lint roller apparatus or assembly of the present invention includes a handle and a lint roll support. The support is in the form of a cross-member extending transversely from the handle. First and second lint roll support members including legs extend from the cross-member and are adapted for receiving and supporting a lint roll therebetween. The lint roll supports or bearing surfaces are fixedly or moveably mounted to the legs.

In one aspect, lint roll supports or bearing surfaces are fixedly or moveably mounted to the legs.

In one aspect, the legs are moveably disposed relative to the cross-member and are coupled by a biasing member which normally biases the legs to a first dimension spacing for supporting a lint roll therebetween. At least one of the legs at a time may be expanded laterally outward from the opposite leg to allow insertion or removal of a lint roll between the legs.

In another aspect, a tubular lint roll support is formed of first and second telescopingly expandable and retractable end portions. A biasing member is carried within the first and second end portions and normally biases the first and second end portions outward to a first dimensional length. The first and second ends may be retracted or compressed toward each other to allow insertion or removal of a lint roll between the legs.

The apparatus of the present invention provides added functionality in lint and other debris removal operations by providing multiple cleaning surfaces or elements in a single tool. Each cleaning element is usable separately so as to enable most types of dirt, lint, debris, etc., to be effectively removed from various surfaces, fabric, clothes, furniture, animals, etc.

In another aspect, a liquid storage chamber is formed in the body. A dispenser means is disposed in fluid communication with the liquid storage chamber for dispensing liquid from the body to assist in cleaning operations.

### BRIEF DESCRIPTION OF THE DRAWING

The various features, advantages and other uses of the present invention will become more apparent by referring to the following detailed description and drawing in which:

FIG. 1 is a side elevational view of one aspect of the present apparatus;

FIG. 2 is a front elevational view of the apparatus shown in FIG. 1;

FIG. 3 is a perspective view of another aspect of a cleaning apparatus according to the present invention;

FIG. 4 is a front elevational view of the cleaning apparatus shown in FIG. 3;

FIG. 5 is a partial, perspective view of a portion of the cleaning apparatus shown in FIGS. 3 and 4;

FIG. 6 is a partial, enlarged, exploded view of the cap mountable on the end of the handle of the cleaning apparatus shown in FIGS. 3-5;

FIG. 7 is an enlarged, partial, exploded view showing an alternate extension handle mountable in the handle of the cleaning apparatus shown in FIGS. 3-5;

FIG. 8 is a partial, exploded view showing the mounting of a depressable dispenser cap on the handle of the cleaning apparatus shown in FIGS. 3-5;

FIG. 9 is a perspective view of another aspect of the cleaning apparatus according to the present invention;

FIG. 10 is a front elevational view of the cleaning apparatus shown in FIG. 9; and

FIG. 11 is an exploded, perspective view of another aspect of the cleaning apparatus according to the present invention.

### DETAILED DESCRIPTION

In the various lint rollers described hereafter, a tape roll 30, is any commercially available tape roll having outwardly facing adhesive sheets or strips, generally arranged in a plurality of sheets wound in a roll wherein the outermost sheets are peelable from the roll, one at a time, along perforated edges of each sheet. When the roll 30 is mounted on a support, the roll 30 may freely rotate under applied force to remove lint, pet hair, and other debris from surfaces, such as clothes, furniture, or other fabrics.

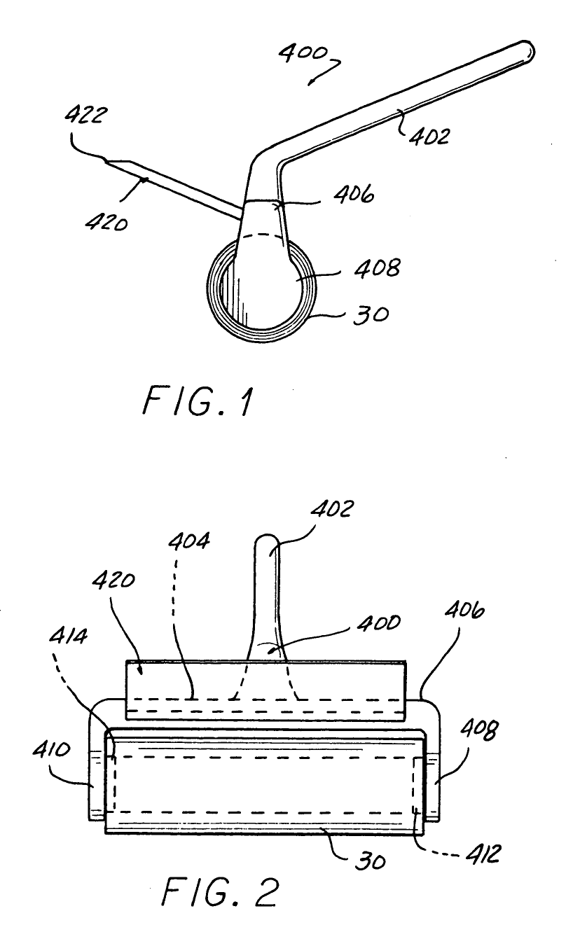

Referring now to FIGS. 1 and 2, there is depicted yet one aspect of the present lint roller/brush apparatus denoted generally by reference number 400. The apparatus 400 includes a body which may be integrally formed, such as from a blow molded plastic, or assembled of individual components fixedly joined together into unitary structure by heat or sonic welding, fasteners, etc.

The apparatus 400 includes an elongated handle 402 which has an ergonomic shape for easy hand gripping. Alternately, the handle 402 may be formed with a hollow interior chamber suitable for receiving a cleaning liquid. A dispenser, such as a push top or trigger type may be mounted on the end of the handle 402 to dispense cleaning liquid from the handle 402.

A further optional adaptation is the provision of snap or screw together, threaded connections on the end of the handle 402 for connection to an elongated handle or handle extension, not shown, to enable the apparatus 400 to be conveniently used to clean floors, walls, ceilings, or other hard to reach surfaces.

The handle 402 transitions into a cross-member formed of two cross arms 404 and 406 which extend laterally in opposite directions from the end of the handle 402. The arms 404 and 406 terminate in angularly disposed legs 408 and 410, respectively. A pair of generally circular supports 412 and 414 extend axially inward from the legs 408 and 410, respectively, and rotatably fit within the inner diameter of the lint roll 30 which can be snapped over the supports 412 and 414 for insertion or removal from the apparatus 400.

In this aspect, an additional cleaning element in the form of a squeegee 420 is fixedly mounted in the arms 404 and 408 and projects angularly therefrom as shown in FIG. 26. The squeegee 420 has a blade-like shape formed of a resilient, flexible material terminating in one or more pointed edges 322 which, when dragged across the surface, is and are capable of pulling embedded hairs from fabric.

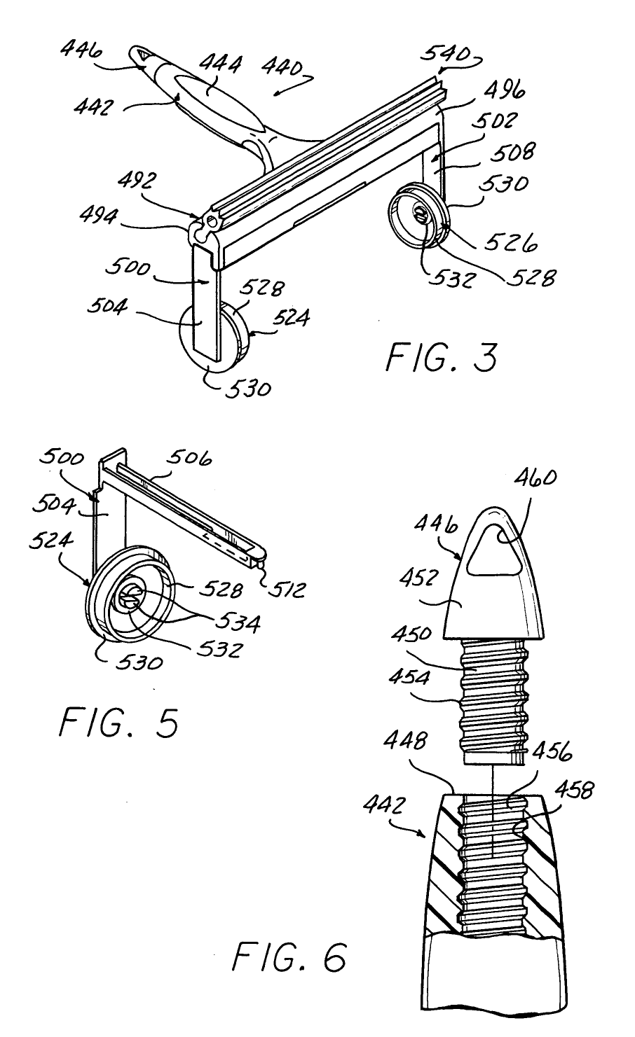

One aspect of a cleaning apparatus 440 according to the present invention is shown in FIGS. 3-6. In this aspect, the cleaning apparatus 440 includes a body which may be integrally formed, such as from a blow-molded plastic or assembled of individual components fixedly jointed together into a unitary structure by heat or sonic welding, fasteners, adhesive, etc. The body is preferably formed of one monolithic piece utilizing materials, such as polyethylene, PET, polyvinyl chloride or similar thermoplastic materials.

The apparatus 440 includes an elongated handle 442 which has an ergonomic shape for easy hand gripping. Resilient inserts 444 may be mounted on the exterior of the handle 442 for a comfortable and secure hand grip.

An end cap 446 is applied to one end 448 of the handle 442. Although a conical shaped end cap 446 is shown in FIGS. 3 and 6, it will be understood that the end cap 446 may take any other shape, including a cylindrical shape or an aesthetic, decorative shape.

The end cap 446 has an externally threaded shank 450 extending from an enlarged end portion 452. The external threads 454 on the shank 450 threadingly engage internal threads 456 in a bore 458 extending inward from the second end 448 of handle 442. The threads 454 and 456 enable the cap 446 to be removably attachable to the handle 442, for reasons which will become apparent hereafter.

Although the cap 446 has been described as being removably attachable to the handle 442, it will be understood that the cap 446 may be non-removably attached by means of a press-fit, adhesive or integral molding with the handle 442.

As also shown in FIG. 6, the handle 446 is provided with an aperture 460 which can have a closed periphery or a discontinuous periphery to provide a hanger feature for the end cap 446 and the remainder of the attached cleaning apparatus 440.

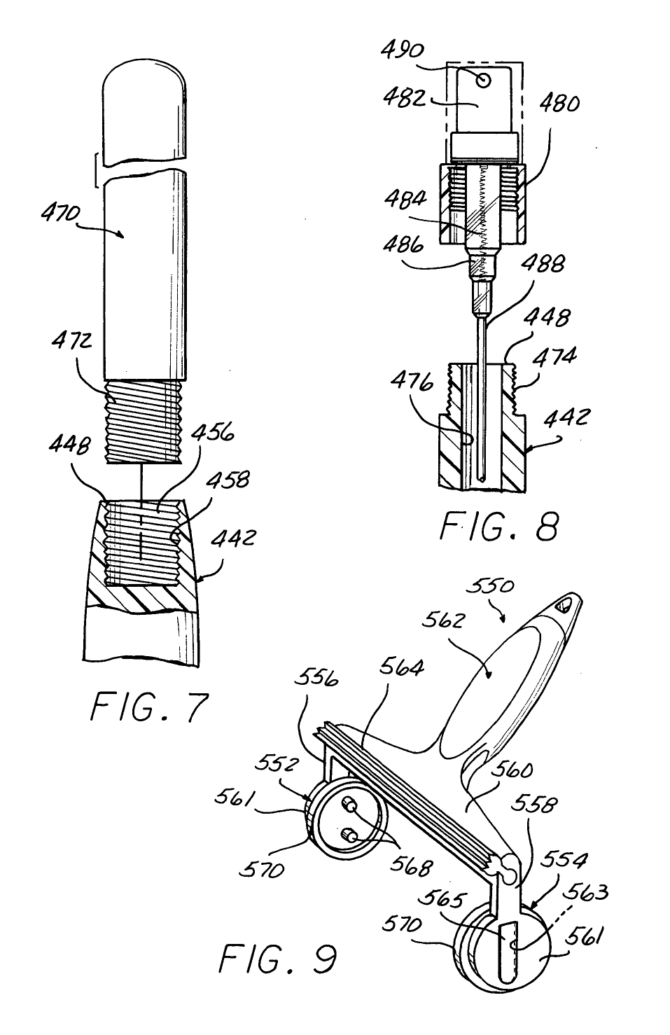

Referring briefly to FIG. 7, there is depicted an extension handle 470 having an externally threaded end 472 which is removably engagable with the threads 456 in the bore 458 on the second end 448 of the handle 442 after the end cap 446 has been removed from the handle 442. The extension handle 470 enables the cleaning apparatus 440 to function as a cleaning device to remove debris from a floor or other surface beyond the normal arm reach of the user.

It will be understood that the extension rod 470 can also be attached to the handle 442 by press-fit, interlocking projections and grooves, or by other releaseable attachment means.

Referring briefly to FIG. 8, there is depicted another aspect of the cleaning apparatus 440 which provides a cleaning liquid dispersion function for the cleaning apparatus 440. In this aspect of the invention, a modified handle 442′ has a reduced diameter portion adjacent the second end 448. The periphery of the reduced diameter portion of the handle 442′ is externally threaded as shown by threads 474. A hollow bore 476 extends through the handle 442 to an internal chamber within the handle 442 which is capable of storing cleaning liquid.

A conventional fluid dispenser in the form of an interiorly threaded cap 480 having a displaceable button 482 biased away from the end of the cap 480 by an internally mounted biasing means or coil spring 484 is provided for attachment to the handle 442′. A hollow stem 486 extends through and out of the cap 480 and supports a fluid conduit 488 which extends into the chamber in the handle 442′. The other end of the fluid conduit 488 is fluidically coupled to a fluid outlet or nozzle 490 mounted in the depressable button 482. Depression of the button 482 will cause fluid to be drawn through the conduit 488 and dispensed through the outlet or nozzle 490.

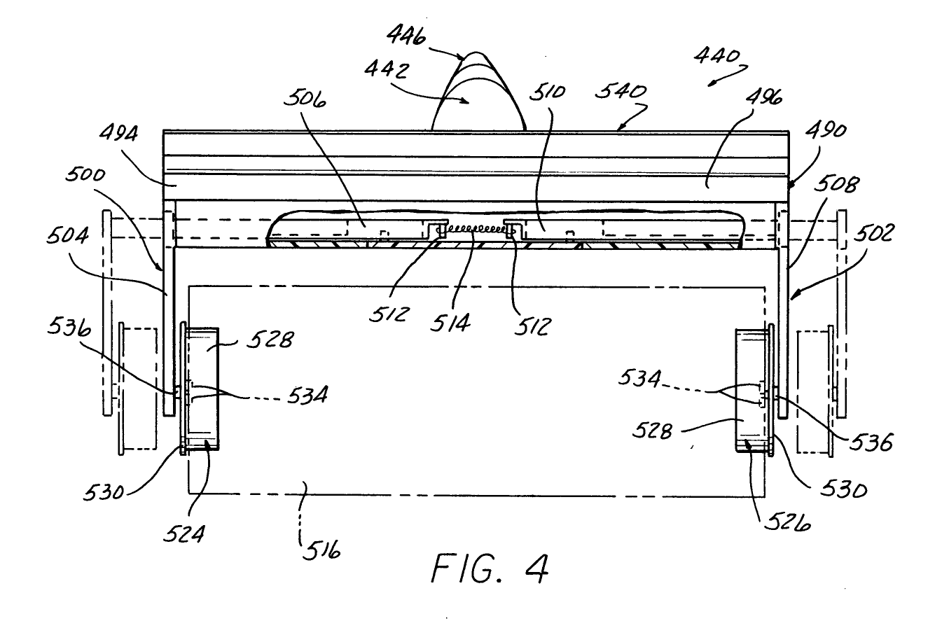

Referring back to FIGS. 3 and 4, the handle 442 transitions into a lint roll support, including a cross-member 492. The cross-member 492, although generally formed of one piece, has two arms 494 and 496 which project laterally and oppositely outward from one end of the handle 442. A pair of roll support assemblies 500 and 502 are mounted on the arms 494 and 496, preferably with at least one and preferably both of the support arm assemblies 500 and 502 being moveably mounted in the arm portions 494 and 496 of the cross-member 492.

Since the support assemblies 500 and 502 are substantially identically constructed, the following description of the support assembly 500 will be understood to apply equally to the construction and operation of the support assembly 502.

As shown in FIGS. 4 and 5, the support assembly 500 includes a leg 504 which depends from a tubular slider or channel member 506. The leg 504 and the channel member 506 may be integrally constructed as a one piece plastic member or formed of two members fixedly joined together by fasteners, adhesive, sonic or heat welding, etc. The channel member 506 is moveably disposed within the hollow interior of the arm 494 of the cross-member 492, as shown in FIG. 4.

As shown in FIGS. 3 and 4, the support assembly 502 includes a similarly constructed leg 508 which is fixedly joined to a slider or channel member 510. The channel member 510 is moveably disposed within the arm 496 of the cross-member 492.

A pin 512 projects from one end of the channel members 506 and 510. A biasing means, such as a coil spring 514, is connected between the pins 512 on the channel members 506 and 508 and functions to bias the support assemblies 500 and 502 inward toward each other. In this position, which is shown in solid in FIGS. 3 and 4, the legs 504 and 508 are disposed immediately adjacent the ends of the arm portions 494 and 496 of the cross-member 492. Open ended slots may be formed in the ends of the arms 494 and 496 to enable the legs 504 and 508 to fit within the ends of the arms 494 and 496 as shown in solid in FIGS. 3 and 4.

The biasing force exerted by the spring 514 holding the support assemblies 500 and 502 together at a first spacing sized to support a lint roll 516 between the legs 504 and 508 can be overcome by lateral outward force exerted on at least one of the legs 504 and 508 in a direction pulling the one or both legs 504 and 508 outward from the end of the associated arm 494 and 496 to a position shown in phantom in FIG. 4. Although it is only necessary to pull one of the support assemblies 500 and 502 laterally outward to a second spacing with respect to the opposed support assembly 500 and 502 to enable removal and/or mounting of a lint roll 516 to the support assemblies 500 and 502, as described hereafter, both of the support assemblies 500 and 502 can be laterally urged outward to the expanded position shown in phantom in FIG. 4.

Release of the laterally outward directed force on the support assemblies 500 and/or 502 will enable the biasing spring 524 to pull the one or both support assemblies 500 and 502 back toward the close together, inward position shown in FIGS. 3 and 4.

Referring to FIGS. 3, 4, and 5, bearing surfaces in the form of generally circular members 524 and 526 are fixed or rotatably mounted on one end of the legs 504 and 508, respectively. Each member 524 and 526 has a first outer diameter circular rim 528 which extends from one surface of a larger diameter end wall 530. The end wall 530 abuts the end of the lint roll 516 as shown in FIG. 4, with the end portions of the lint roll 516 resting on the outer diameter of the circular runs 528. An annular disk 532 is centrally carried on each end wall 530 within the circular wall 528. An aperture is formed in the disk 532 and receives resilient latch members 534 which are spaced apart on one end of a stem 536 integrally joined to and extending from one end of the leg 504 or the leg 508. The ends of the latch members 534 extend outward from the stem 536 to form an end projection which snaps over the inner wall of the annular disk 532 to latch the circular supports 524 and 526 to the legs 504 and 506, respectively.

The above-described connection defines a rotatable connection allowing the circular members 524 and 526 to rotate along with the lint roll 516 mounted thereon as the lint roll 516 is forcibly urged across a surface to be cleaned.

Finally, as shown in FIGS. 3 and 4, cleaning apparatus 40 includes an additional cleaning element 540 which is mounted in the cross-member 492 and projects outward therefrom. The additional cleaning element 540 can be one of a number of different cleaning elements used to provide an added cleaning capability to the cleaning apparatus 440. Thus, although the cleaning element 540 is depicted as being in the form of a resilient squeegee having one or more blades formed of a resilient, flexible material, each terminating in a pointed edge which, when dragged across a surface, is capable of pulling embedded hairs from fabric the cleaning element 540 can take other forms, such as a premoistened wipe strip(s), rotatable crumb pickers, etc. The cleaning element 540 is removably mountable in the cross-member 492 such as by a slide-in fit as shown in FIG. 3. Other types of releasable connections, including fasteners, or more permanent connections, such as through the use of adhesive or mechanical fasteners, may also be employed to mount the cleaning element 540 in the cross-member 492. The cleaning element can also be fixed in the cross-member 492.

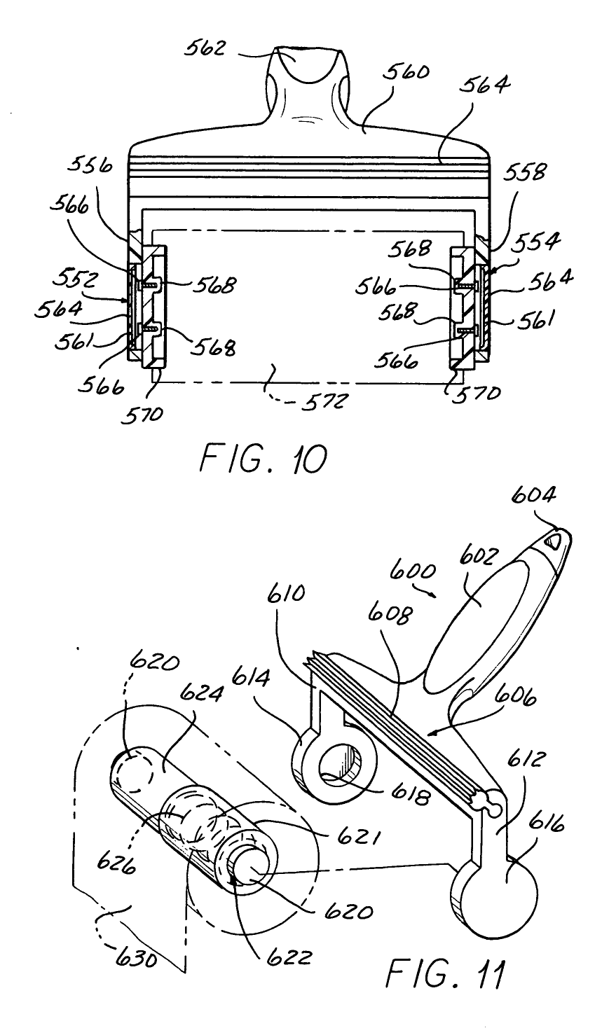

Referring now to FIGS. 9 and 10, there is depicted another aspect of a cleaning apparatus 550 which is substantially similar to the cleaning apparatus 440 except for the mounting of the circular lint roll supports 552 and 554 to the ends of the legs 556 and 558, respectively, of a cross-member 560 mounted transversely at one end of a handle 562. An additional cleaning element, such a squeegee 564, by example only, can also be mounted in the cross-member 560.

In this aspect, each leg 556 and 558 terminates in a generally circular base 561. A slot 563 is formed in each base 561 and can be closed by a snap-in cover 565. The slots 563 provide access to at least one and preferably a pair of fasteners, such as screws 566 which fixedly engage the circular bases 561 to fix the bases 561 to the legs 556 and 558.

The fasteners 566 extend into inward extending projections 568 which project inwardly from an inner wall of each circular support 552 and 554. An outer peripheral surface 570 of each circular support 552 and 554 acts as a bearing surface for a lint roller 572 which can be rotatably mounted thereover.

Finally, another aspect of a cleaning apparatus 600 according to the present invention is shown in FIG. 11. The cleaning apparatus 600 shares many of the same features as the cleaning apparatus 440 and 550 in that it includes a handle 602 which has an end cap 604 mounted at one end and a laterally extending cross-member 606 at an opposite end. A cleaning element 608, such as a squeegee, may optionally be mounted in the cross-member 606.

A pair of legs 610 and 612 extend from opposite ends of the cross-member 606 and terminate in enlarged bases 614 and 616. A recess 618 extends axially inwardly partially through each circular base 614 and 616. An inner circumferential surface of each recess 618 acts as a bearing surface for an outwardly extending projection 620 of a cylindrical shaped member 621 telescopingly disposed over a second cylindrical member 624. A similar bearing surface 620 is formed on the outer end of the second member 624. The members 621 and 624 form a lint roll support tube 622 on which a lint roll 630 is placed.

An internally disposed biasing means, such as a coil spring 626, is disposed between the ends of the members 621 and 624 and biases the ends of the members 621 and 624 outward, but enables the overall length of the support tube 622 to be shortened to allow the tube 622 to be inserted between the bases 614 and 616 of the cleaning apparatus 600 to remove or install a lint roll 630 between the leg 610 and 612 of the cleaning apparatus 600.

In summary, there has been disclosed numerous aspects of a combination lint roll/brush apparatus which is useful in efficiently removing dirt, debris, embedded hair, from fabrics and other surfaces. The apparatus combines several cleaning elements into a single apparatus thereby affording many different cleaning uses with a single apparatus. This enables different types of debris to be successfully removed from fabrics, furniture, clothing, and other surfaces by choosing one or more of the different cleaning elements in a single cleaning operation.

What is claimed is:

1. A lint roller apparatus comprising:
a body having a handle and a support portion, the support portion receiving a particle removing material; and
the support portion first and second lint roll supports adapted for engaging opposed ends of a lint roll, the first and second lint roll supports extending from the handle of the body.

2. The apparatus of claim 1 wherein the support portion comprises:
a cross-member extending transversely from the handle.

3. The apparatus of claim 1 further comprising:
a lint roll support member carried on each of the legs.

4. The apparatus of claim 3 further comprising:
means for rotatably mounting the lint roll support members on the legs.

5. The apparatus of claim 4 wherein the rotatably mounting means comprises:
a stem projecting from each leg; and
one lint roll support member rotatably mounted on the stem.

6. The apparatus of claim 2 further comprising:
means for removably mounting each leg in the cross-member.

7. The apparatus of claim 6 wherein the movably mounting means comprises:
a slide portion extending from each leg, the slide portion moveably disposed within the cross-member.

8. The apparatus of claim 7 further comprising:
biasing means coupled to the slide portions of each of the legs for normally biasing the legs toward each other at a first normal spacing, the biasing means allowing at least one of the legs to be urged away from the opposite leg for relative movement of a lint roll between the legs.

9. The apparatus of claim 8 wherein:
the biasing means is a spring.

10. The apparatus of claim 6 further comprising:
a lint roll support member carried on each of the legs.

11. The apparatus of claim 10 further comprising:
means for rotatably mounting the lint roll support member on each of the legs.

12. The apparatus of claim 11 wherein the rotatably mounting means comprises:
a stem projecting from each leg; and
one lint roll support member rotatably mounted on the stem

13. The apparatus of claim 3 wherein:
the lint roll support members are fixedly mounted on the legs.

14. The apparatus of claim 13 further comprising:
a lint roll support tube carrying the lint roll, the lint roll support tube having first and second extendable ends;
biasing means, carried within the lint roll support, and normally biasing first and second ends retractably outward with respect to each other.

15. The apparatus of claim 14 further comprising:
projections extending outward from the first and second ends;
a recess in each leg defining a bearing surface for one projection to rotatably mount the lint roll support tube between the legs.

16. The apparatus of claim 3 further comprising:
the lint roll carrier carrying the lint roll, the lint roll carrier having first and second extendable ends;
biasing means, carried within the lint roll support, and normally biasing first and second ends retractably outward with respect to each other.

17. The apparatus of claim 16 further comprising:
projections extending outward from the first and second end;
a recess in each leg defining a bearing surface for one projection to rotatably mount the lint roll support tube between the legs.

18. The apparatus of claim 1 further comprising:
an end cap affixed to one end of the handle.

19. The apparatus of claim 18 wherein the end cap comprises:
a decorative end cap.

20. The apparatus of claim 18 wherein the end cap comprises:
a hanger portion for mounting the apparatus on a support.

21. The apparatus of claim 18 wherein:
the end cap is removably mounted to the handle portion;

22. The apparatus of claim 1 wherein:
the body is a one piece, monolithic body.

23. The apparatus of claim 1 further comprising:
a liquid storage chamber carried on the body; and
fluid dispenser means disposed in fluid communication with the liquid storage chamber for dispensing fluid;

24. The apparatus of claim 23 wherein:
the liquid storage chamber is formed internally within the body.

25. The apparatus of claim 23 wherein:
the body includes an open ended bore extending from one end; and
the liquid storage chamber is carried in a separate member mountable in the bore in the body, the separate member carrying the dispenser means.

26. The apparatus of claim 23 wherein:
the fluid dispenser means is removably mounted on the handle;

27. The apparatus of claim 26 further comprising:
a plurality of threads carried on the handle; and
a plurality of threads carried on the fluid dispenser means engagable with the threads on the handle to threadingly couple the fluid dispenser means to the handle.

28. The apparatus of claim 2 further comprising:
an additional cleaning element carried on the cross-member.

29. The apparatus of claim 21 further comprising:
a internally threaded bore formed in the handle; and
an externally threaded shank carried on the end cap for threadingly engaging the end cap with the handle.

30. The apparatus of claim 1 further comprising:
a plurality of threads carried on one end of the handle; and
an elongated rod having threads at one end threadingly engagable with the threads on the handle to threadingly couple the rod to the handle.
